(19) United States
(12) Patent Application Publication
(10) Pub. No.: US 2019/0138253 A1
(43) Pub. Date: May 9, 2019

(54) IMAGE FORMING APPARATUS AND RECORDING MEDIUM SUITABLE FOR PRINTING PROCESS

(71) Applicant: KYOCERA Document Solutions Inc., Osaka (JP)

(72) Inventor: Daiki SONE, Osaka (JP)

(73) Assignee: KYOCERA Document Solutions Inc., Osaka (JP)

(21) Appl. No.: 16/182,089

(22) Filed: Nov. 6, 2018

(30) Foreign Application Priority Data
Nov. 6, 2017 (JP) 2017-213775

(51) Int. Cl. G06F 3/12

(52) U.S. Cl. CPC G06F 3/1214; G06F 3/1253; G06F 3/1274

(57) ABSTRACT

Provided is an image forming apparatus that further improves performance of a printing process. A RAM (storage device) stores printing data. An image-processing unit performs image processing on the printing data. A printer unit forms an image on paper based on processed data that is processed by the image processing. A system-control unit, after printing data is selected via the panel unit, instructs the image-processing unit to perform image processing on the selected printing data, and after there is an instruction via the panel unit to start printing, instructs the printer unit to form the image. As a result, at the instant when printing data is selected via the panel unit, the image-processing unit 118 executes image processing on the printing data, and at the instant when there is an instruction via the panel unit to start printing, the printer unit executes image formation.

### INCORPORATION BY REFERENCE

This application is based on and claims the benefit of priority from Japanese Patent Application No. 2017-213775 filed on Nov. 6, 2017, the contents of which are hereby incorporated by reference.

### BACKGROUND

The present disclosure relates to an image forming apparatus and a recording medium suitable for a printing process.

For example, in an image forming apparatus that is a multifunction peripheral (MFP) such as a combination machine and the like, there are models equipped with a printing function, a copying function, a FAX function, a data transmitting/receiving function via a network, and the like. In addition, of image forming apparatuses, there also models that are equipped with a box printing function for receiving a printing job from a user terminal connected via a network such as a LAN (Local Area Network) or the like, and registering the printing job in a storage device such as a hard disk drive (HDD) or the like. Incidentally, printing of the printing job registered in the storage device can be executed after a user authentication process in the panel unit of the image forming apparatus.

Regarding this kind of box printing, in a typical technique, an acquisition unit acquires raster data generated by a RIP process from a print controller that executes RIP processing (rasterization processing) on a printing job. A storage unit stores the acquired raster data. A receiving unit receives specifications by a user. A determination-requesting unit requests that the print controller determine whether or not the RIP process is necessary again. This determination is for at least one item of raster data among the raster data stored in the storage unit and specified by the user via the reception unit. The determination-requesting unit requests that the print controller determine whether or not RIP processing is necessary again for the at least one item of raster data stored in the storage unit at a timing specified by the user via the receiving unit. An execution-requesting unit requests that the print controller execute the RIP process again. This is based on the result of determination by the print controller of whether or not the RIP process is necessary again. There are such image forming apparatuses.

### SUMMARY

The image forming apparatus according to the present disclosure includes a panel unit, a storage device, an image-processing unit, a printer unit, and a system control unit. The storage device stores printing data. The image-processing unit performs image processing on the printing data. The printer unit forms an image on paper based on processed data that is processed by the image processing. The system-control unit, after printing data is selected via the panel unit, instructs the image-processing unit to perform image processing on the selected printing data, and after there is an instruction via the panel unit to start printing, instructs the printer unit to form the image.

The recording medium according to the present disclosure is a non-transitory computer-readable recording medium for storing an image forming program executable on a computer of an image forming apparatus. When the computer executes the image forming program, the computer by a storage device stores printing data. The computer by an image-processing unit performs image processing on the printing data. The computer by a printer unit forms an image on paper based on processed data that is processed by the image processing. The computer by a system-control unit, after printing data is selected via the panel unit, instructs the image-processing unit to perform image processing on the selected printing data, and after there is an instruction via the panel unit to start printing, instructs the printer unit to form the image.

### BRIEF DESCRIPTION OF THE DRAWINGS

FIG. 1 is a diagram illustrating an embodiment in a case where an image forming apparatus according to the present disclosure is applied to an MFP.

FIG. 2 is a flowchart for explaining image processing by the MFP in FIG. 1.

FIG. 3 is a flowchart for explaining image processing by a typical MFP.

### DETAILED DESCRIPTION

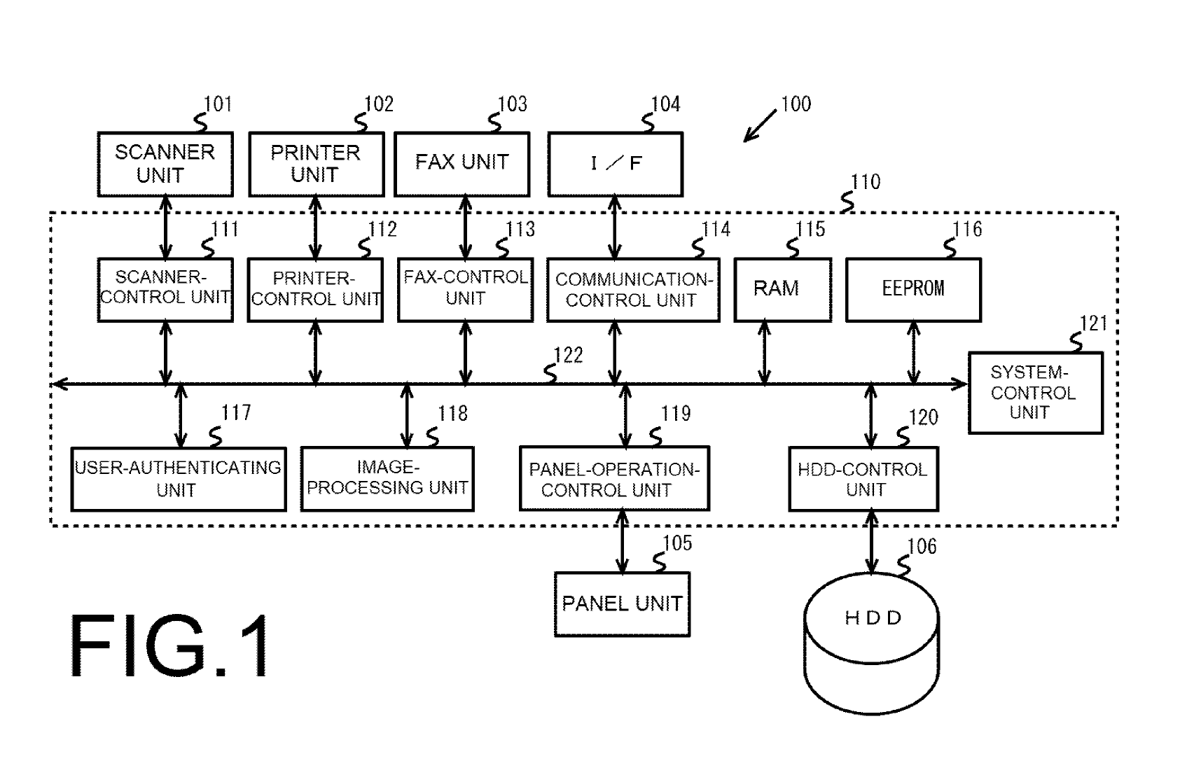

Hereinafter, an embodiment of the image forming apparatus according to the present disclosure will be described with reference to FIG. 1 to FIG. 3. Note that as an example of an image forming apparatus in the following explanation is a multifunction peripheral (MFP) that is a complex peripheral apparatus equipped with a printing function, a copying function, a FAX function, a data transmitting and receiving function via a network, and the like.

First, as illustrated in FIG. 1, the MFP 100 includes a control unit 110 that controls operations of a scanner unit 101, a printer unit 102, a facsimile (FAX) unit 103, an I/F (interface) 104, a panel unit 105, and an HDD 106.

The scanner unit 101 is a device that converts an image of a document read by an image sensor into digital image data and inputs the digital image data to the control unit 110. The printer unit 102 is a device that prints an image on paper based on processed data that is outputted from the control unit 110 and that has undergone image processing (rasterization). The FAX unit 103 is a device that transmits data outputted from the control unit 110 to a facsimile of another party through a telephone line, and receives data from a facsimile of another party and inputs that data to the control unit 110.

The I/F 104 is connected to an information-providing server or the like via a network. Incidentally, the I/F 104 may be responsible for communication with other MFPs, user terminals, and the like, and may also be responsible for communication with a content server, a web server, or the like. The panel unit 105 is a device such as a touch panel or the like that performs a display for a printing function, a copying function, a FAX function, a data transmitting/receiving function via the network, and for various settings (including printing settings and the like) of the MFP 100. In addition, the panel unit 105 displays a start button indicating the start of printing, copying, a FAX, and data transmission/reception. Note that the start button may be provided separately from the panel unit 105. The HDD 106 is a storage device that stores application programs and the like for providing the various functions of the MFP 100. Moreover, the HDD 106, for example, has a user box for storing printing jobs registered from the user terminal side, printing correspondence data in page description language, and the like.

The control unit 110 is a processor that controls the overall operation of the MFP 100 by executing an application program such as an authentication program or the like, an image forming program, a control program, and the like. The control unit 110 includes a scanner-control unit 111, a printer-control unit 112, a FAX-control unit 113, a communication-control unit 114, a random access memory (RAM) 115, an electrically erasable and programmable read-only memory (EEPROM) 116, a user-authenticating unit 117, an image-processing unit 118, a panel-operation-control unit 119, an HDD-control unit 120, and a system-control unit 121. In addition, these units are connected to a data bus 122.

The scanner-control unit 111 controls the reading operation of the scanner unit 101. The printer-control unit 112 controls the printing operation of the printer unit 102. The FAX-control unit 113 controls the data transmitting/receiving operation by the FAX unit 103. The communication-control unit 114, via the I/F 104, controls transmission and reception of data and the like via the network.

The RAM 115 is a work memory for executing a program. In addition, the RAM 115 stores processed data that has undergone image processing (rasterization) by the image-processing unit 118. The EEPROM 116 stores a control program for performing a check of the operation of each unit and the like. The EEPROM 116 also stores firmware and the like for operating the scanner unit 101, the printer unit 102, the FAX unit 103, the I/F (interface) 104, the panel unit 105, the HDD 106, and the like.

The user-authenticating unit 117 performs user authentication based on user-authentication information such as a user ID (Identification) and the like. This, for example, is performed when registering a printing job in the HDD 106 from the user terminal, or when receiving a login process via the panel unit 105. Incidentally, when performing user authentication, the user-authenticating unit 117 checks whether or not user-authentication information already registered in the HDD 106 or the like, coincides with user-authentication information transmitted from a user terminal, or user-authentication information inputted via the panel unit 105. For example, the image-processing unit 118 performs image processing (rasterization) on printing data registered in a user box of the HDD 106. In addition, the image-processing unit 118 performs image processing (rasterization) on image data read by the scanner unit 101. Moreover, the image-processing unit 118 temporarily stores processed data that has undergone image processing (rasterization) in the RAM 115.

The panel-operation-control unit 119 controls the display operation of the panel unit 105. In addition, in the login process, the panel-operation-control unit 119 receives input of user-authentication information via the panel unit 105. Moreover, the panel-operation-control unit 119 receives the start of printing, copying, a FAX, data transmission/reception via the network, or the like via the panel unit 105. Furthermore, the panel-operation-control unit 119 receives, for example, a selection of printing data registered in a user box of the HDD 106, printing settings, and the like via the panel unit 105. Here, the panel-operation-control unit 119, via the panel unit 105, may cause a selection screen for selecting printing data to be displayed as a list of printing data. In addition, the panel-operation-control unit 119, via the panel unit 105, may cause a setting screen for changing printing-setting items and setting contents to be displayed.

The system-control unit 121 controls the cooperative operation of each unit, and the like. In addition, after copying, printing, or the like has been selected via the panel unit 105, the system-control unit 121, via the scanner control unit 111 or the printer control unit 112, controls reading of a document by the scanner unit 101, and printing on paper by the printer unit 102. In addition, the panel-operation-control unit 119 receives a selection of printing data registered in a user box of the HDD 106, for example, via the panel unit 105. Then, the system-control unit 121 instructs the image-processing unit 118 to perform image processing (rasterization) on the selected printing data. In addition, after the panel-operation-control unit 119 receives, for example, a printing start instruction as the start button is pressed (touch operation) via the panel unit 105, the system-control-unit 121 instructs the printer unit 102 to perform a printing process.

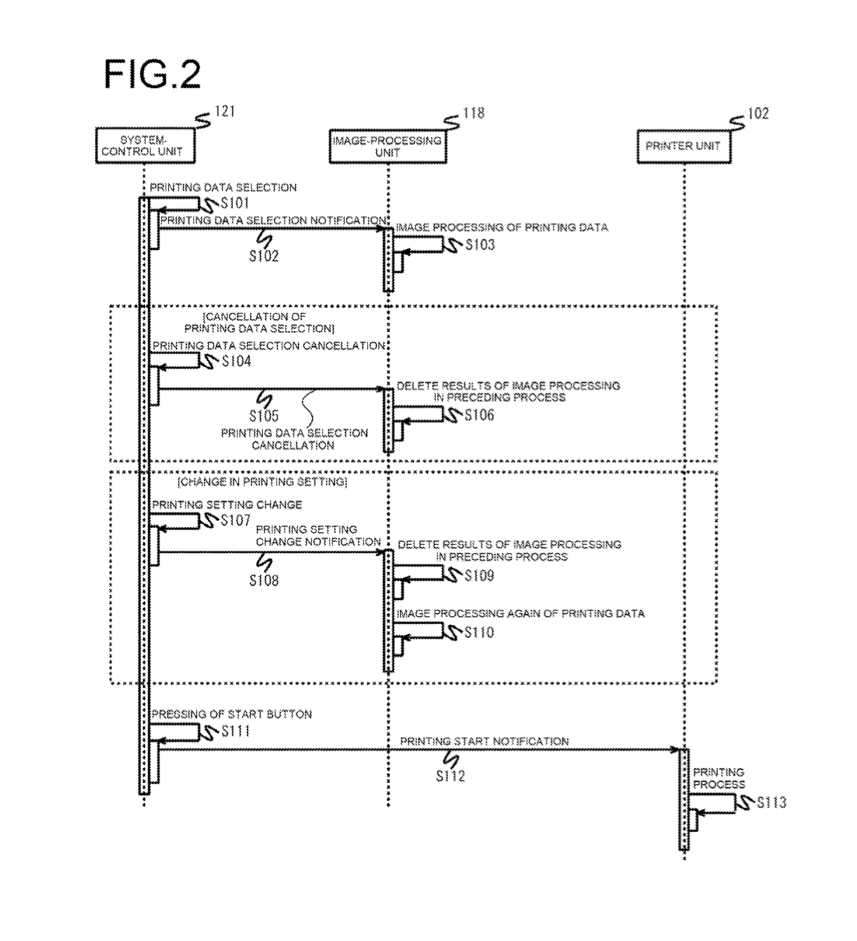

Next, an example of image processing by the MFP 100 will be described with reference to FIG. 2. Note that FIG. 2 illustrates image processing by the MFP 100 in the present embodiment. In addition, the following image processing will be explained as image processing for printing data registered in a user box of the HDD 106. Moreover, in the following, image processing for the case where user authentication by the user-authenticating unit 117 has been completed will be explained.

### (Steps S101, S102)

After printing data is selected, the system-control unit 121 notifies the image-processing unit 118 of the selected printing data. In this case, after receiving a notification indicating that selection of printing data has been received from the panel-operation-control unit 119 via the panel unit 105, the system-control unit 121 notifies the image-processing unit 118 of the selected printing data. Incidentally, this notification includes an instruction for performing image processing on the printing data. In addition, the system-control unit 121 reads the selected printing data from the HDD 106 and stores the printing data in the RAM 115. Moreover, the panel-control unit 119 receives the selection of printing data after any of the printing data in the list of printing data on a selection screen has been specified. Here, “any of the printing data has been specified” means, for example, that any of the printing data in the list is a reverse displayed.

### (Step S103)

The image-processing unit 118 performs image processing (rasterization) on the printing data.

In this case, the image-processing unit 118 stores the processed data that has undergone image processing (rasterization) in the RAM 115.

### (Steps S104, S105)

When the printing data selection is cancelled, the system-control unit 121 issues a printing-data-selection-cancellation notification to the image-processing unit 118. In this case, after once receiving a notification that accepts the selection-cancellation of the selected printing-data from the panel-operation-control unit 119 via the panel unit 105, the system-control unit 121 notifies the image-processing unit 118 of the printing-data-selection-cancellation notification indicating that the selection of the printing data is cancelled. Here, after the specification of printing data specified in the list of printing data on the selection screen is cancelled, the panel-control unit 119 receives the cancellation of the selection of printing data. Here, “specification of printing data specified in the list of printing data is cancelled” means, for example, that the specified printing data in the list is returned from the reverse displayed to the normal display.

In the case where a printing-data-selection cancellation is received in step S104, the system-control unit 121 waits for selection of printing data in step S101.

### (Step S106)

The image-processing unit 118 deletes the processed data that is the result of the image processing (rasterization) in the preceding process.

In this case, the image-processing unit 118 deletes the processed data for the printing data in the preceding process that is stored in the RAM 115.

When there is a change in a printing setting, the system-control unit 121 issues a printing-setting-change notification to the image-processing unit 118. In other words, after a notification indicating a change of a printing setting for the printing data selected in step S101 has been received from the panel-operation-control unit 119 via the panel unit 105, the system-control unit 121 notifies the image-processing unit 118 of the change of the printing setting for the printing data. Incidentally, the printing settings include various printing settings such as the number of prints, printing density, font, and the like, and any of the content can be arbitrarily changed. In addition, the panel-control unit 119 receives a change in a printing setting when the setting content of any setting item on the setting screen is changed.

### (Steps S109, S110)

The image-processing unit 118 deletes the processing data that is the result of the image processing (rasterization) in the preceding process.

In this case, the image-processing unit 118 deletes the processed data for the printing data in the preceding process that is stored in the RAM 115.

Moreover, the image-processing unit 118 performs image processing (rasterization) on the printing data selected in step S101 based on the content of the printing setting change in step S108, and stores the processed data that has undergone image processing in the RAM 115.

### (Steps S111, S112)

As the start button is pressed (touch operation), the system-control unit 121 issues a printing-start notification to the printer unit 102. In this case, after the system-control unit 121 receives a notification from the panel operation control unit 119 via the panel unit 105 indicating the start of printing that accompanies pressing of the start button (touch operation), the system-control unit 121 issues a printing-start notification to the printer unit 102.

Here, in the case where there is no printing-data-selection cancellation in step S104 or a printing-setting change in step S107, the system-control unit 121 instructs the printer unit 102 to start printing according to default settings based on processed data for the printing data selected in step S101.

On the other hand, in the case where a printing-data-selection cancellation is received in step S104, the system-control unit 121 instructs the printer unit 102 to start printing based on processed data for the printing data newly selected in step S101. In the case where there is a change in a printing setting in step S107, the system-control unit 121 instructs the printer unit 102 to start printing based on the processed data for the printing data of which a printing setting has been changed in step S107.

### (Step S113)

The printer unit 102 executes a printing process.

In this case, the printer unit 102 forms an image on paper based on the processed data that has undergone image processing (rasterization) and is stored in the RAM 115.

As described above, in the image processing by the MFP 100 according to the present embodiment, after the printing data is selected in step S101, the image-processing unit 118 performs the image processing (rasterization) in step S103. In addition, after a printing data selection is cancelled in step S104, the processed data that is a result of the image processing in step S106 by the image-processing unit 118 is deleted. Next, image processing is performed on the selected printing data. Moreover, after a printing setting is changed in step S107, the processed data that is a result of the image processing in step S109 by the image processing unit 118 is deleted, and image processing for the printing data of which a printing setting has been changed in step S110 is performed. Then, in step S111, after receiving the start of printing accompanying pressing of the start button (touch operation), the printer unit 102 forms an image on paper in step S113. In other words, as soon as printing data is selected, the image-processing unit 118 executes image processing, and after receiving of start of printing accompanying pressing of the start button (touch operation), the printer unit 102 immediately forms an image on paper.

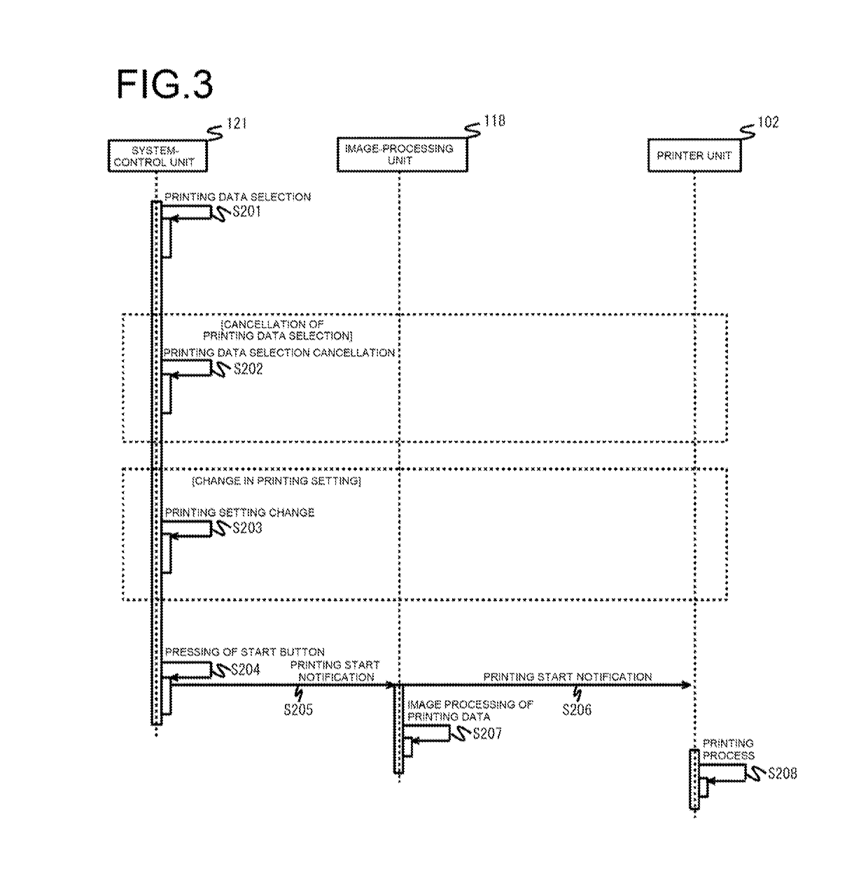

Next, typical image processing by the MFP 100 will be explained with reference to FIG. 3. Incidentally, in the following, similar to as described above, image processing will be explained as image processing for printing data registered in a user box of the HDD 106. Moreover, in the following, image processing for the case where user authentication by the user-authenticating unit 117 has been completed will be explained.

### (Step S201)

After printing data is selected, the system-control unit 121 reads the selected printing data from the HDD 106.

In this case, after receiving a notification indicating that selection of printing data has been received from the panel operation control unit 119 via the panel unit 105, the system-control unit 121 reads the selected printing data from the HDD 106 and stores the printing data in the RAM 115.

### (Step S202)

After the printing data selection is cancelled, the system-control unit 121 deletes the printing data stored in the RAM 115.

### (Step S203)

When a printing setting is changed, the system-control unit 121 retains the changed content of the printing setting.

Incidentally, the printing settings include various printing settings such as the number of prints, printing density, font, and the like, and any of the content can be arbitrarily changed.

### (Steps S204, S205, S206)

After the start button is pressed (touch operation), the system-control unit 121 issues a printing-start notification to the image-processing unit 118 and the printer unit 102.

In this case, after receiving the notification from the panel operation control unit 119 via the panel unit 105 indicating receiving of the start of printing accompanying pressing of the start button (touch operation), the system-control unit 121 notifies the image-processing unit 118 and the printer unit 102 of the start of printing.

Here, in the case where there is no printing-data-selection cancellation in step S202 or a printing-setting change in step S203, the system-control unit 121 instructs the start of printing by default settings for the printing data selected in step S201.

On the other hand, in the case where a printing-data-selection cancellation is received in step S202, the system control unit 121 instructs the printer unit 102 to start printing based on the processed data for the printing data newly selected in step S201. Moreover, in the case where a printing setting is changed in step S203, the system-control unit 121 instructs the printer unit 102 to start printing based on the processed data for the printing data of which a printing setting has been changed in step S203.

### (Step S207)

The image-processing unit 118 performs image processing (rasterization) on the printing data.

In this case, the image-processing unit 118 stores the processed data that has undergone image processing (rasterization) in the RAM 115.

### (Step S208)

The printer unit 102 executes a printing process.

In this case, the printer unit 102 waits until the processed data that has undergone image processing by the image-processing unit 118 is stored in the RAM 115, confirms that the processed data is stored in the RAM 115, and then forms an image on paper based on the processed data.

As described above, in typical image processing, after selection of printing data in step S201 is performed and after receiving the start of printing accompanying the pressing of the start button (touch operation) in step S204, image processing by the image-processing unit 118 is executed in step S207. In other words, since image processing on the printing data by the image-processing unit 118 is not performed until the start of printing accompanying pressing of the start button (touch operation) is received, the formation of an image on paper by the printer unit 102 is kept waiting.

In this way, in the present embodiment, the RAM 115 (storage device) stores printing data, the image-processing unit 118 performs image processing on the printing data, the printer unit 102 forms an image on paper based on processed data by image processing, and after selecting the printing data via the panel unit 105, the system-control unit 121 instructs the image-processing unit 118 to perform image processing on the selected printing data, then after instructing the start of printing via the panel unit 105, instructs the printer unit 102 to form an image.

As a result, at the instant when the printing data is selected via the panel unit 105, the image-processing unit 118 executes image processing on the printing data, and at the instant when the start of printing is instructed via the panel unit 105, the formation of an image is executed by the printer unit 102. As a result, the performance of the printing process can be further improved.

Incidentally, after any printing data in the list of printing data on the selection screen has been specified, the panel-control unit 119 may receive the selection of the printing data after the specified printing data is confirmed. Here, “any printing data is specified” means, for example, that any printing data in the list is reverse displayed. Moreover, “the specified printing data is confirmed” means, for example, that a confirmation key (for example, an “OK” key) on the selection screen is pressed in a state in which any printing data in the list is reverse displayed.

Moreover, a printing data selection cancellation may be received in the case where other specified printing data is confirmed after receiving a selection of printing data and then after a specification of printing data that is specified in the list of printing data on the selection screen is cancelled. Incidentally, here, “a specification of printing data that is specified in the list is cancelled” means, for example, that the specified printing data in the list is returned from the reverse displayed to the normal display. Moreover, here “other specified printing data is confirmed” means, for example, that a confirmation key (for example, an “OK” key) on the selection screen is pressed in a state in which any printing data in the list is reverse displayed.

In addition, the panel-control unit 119 may receive a change in the printing settings when the changed setting content is confirmed after the setting content of any setting item on the setting screen is changed. Here, “the changed setting content is confirmed” means, for example, that a confirmation key (for example, “OK” key) on the setting screen is pressed.

Incidentally, in this embodiment, an example is given in which the MFP 100 is the image forming apparatus, however, the embodiment is not limited to this example, and may be applied to other image forming apparatuses such as a multifunction printer, or the like.

In an image forming apparatus using typical technology as described above as an image forming apparatus related to box printing, the print controller is requested to execute the RIP process again based on the result of determining whether or not RIP processing by the print controller is necessary again. As a result, it is possible to suppress the execution of the RIP process again on all of the raster data at the timing not intended by the user, and it is possible to execute the RIP process again while minimizing a reduction in the throughput of the image forming system.

Incidentally, in the case of box printing by the image forming apparatus, after the user has undergone user authentication via the panel unit, the user selects printing data on the panel unit. In this case, after changing various printing settings such as the number of prints, printing density, font and the like as necessary, the start button is pressed, whereby printing is started based on processed data that has undergone image processing (rasterization). Note that image processing (rasterization) on the printing data is started after the start button is pressed.

Therefore, requesting the print controller to execute the RIP process again is performed in a typical image forming apparatus when the start button is pressed. In this case, even when the start button is pressed, printing on paper is not immediately executed, so the performance of the printing process cannot be further improved.

With the image forming apparatus and the recording medium according to the present disclosure, the image-processing unit executes image processing on printing data at the instant that printing data is selected via the panel unit. Therefore, at the instant there is an instruction via the panel unit to start printing, the printer unit executes image formation, so it is possible to further improve the performance of the printing process.

What is claimed is:

1. An image forming apparatus, comprising:
a panel unit;
a storage device that stores printing data;
an image-processing unit that performs image processing on the printing data;
a printer unit that forms an image on paper based on processed data that is processed by the image processing; and
a system-control unit that after printing data is selected via the panel unit, instructs the image-processing unit to perform image processing on the selected printing data, and that after there is an instruction via the panel unit to start printing, instructs the printer unit to form the image.

2. The image forming apparatus according to claim 1, wherein
the system-control unit, in a case where selection of the printing data is cancelled after the printing data is selected via the panel unit, instructs the image-processing unit to delete the processed data for the preceding selected printing data.

3. The image forming apparatus according to claim 1, wherein
the system-control unit, in a case where a printing setting is changed after the printing data is selected via the panel unit, instructs the image-processing unit to delete the processed data for the preceding selected printing data, and instructs the image-processing unit to perform image processing on the printing data based on the changed printing setting.

4. A recording medium that is a non-transitory computer-readable recording medium for storing an image forming program executable on a computer of an image forming apparatus, and when the computer executes the image forming program:
a storage device stores printing data;
an image-processing unit performs image processing on the printing data;
a printer unit forms an image on paper based on processed data that is processed by the image processing; and
a system-control unit, after printing data is selected via the panel unit, instructs the image-processing unit to perform image processing on the selected printing data, and after there is an instruction via the panel unit to start printing, instructs the printer unit to form the image.
